(19) United States
(12) Patent Application Publication
(10) Pub. No.: US 2002/0174935 A1
(43) Pub. Date: Nov. 28, 2002

(54) Methods for manufacturing patterned ceramic green-sheets and multilayered ceramic packages

(75) Inventors: Jeremy W. Burdon, Scottsdale, AZ (US); David L. Wilcox, Chandler, AZ (US)

Correspondence Address: MOTOROLA, INC., CORPORATE LAW DEPARTMENT - #56-238, 3102 NORTH 56TH STREET, PHOENIX, AZ, 85018, US

(73) Assignee: Motorola, Inc.

(21) Appl. No.: 09/865,330

(22) Filed: May 25, 2001

(51) Int. Cl. C03B 29/00

(52) U.S. Cl. 156/89.11

(57) ABSTRACT

Cast-on-resist (COR) methods of manufacturing patterned ceramic layers that can be used in forming a multilayered ceramic device are provided according to preferred exemplary embodiments of the present invention. The COR methods are comprised of processing steps that are conducted on a transporting system and include: depositing a resist on a substrate (102) and selectively exposing the resist to a radiation source (104) such that a first portion of the resist having a positive image of the pattern is soluble in a solvent and a second portion of the resist having a negative image of the pattern is insoluble in the solvent, immersing the resist in the solvent to remove the first portion to form a casting substrate having the negative image of the pattern (106), applying ceramic slurry on the casting substrate (204), curing the ceramic slurry on the casting substrate (206), and removing the ceramic slurry from the casting substrate after the curing such that a patterned ceramic layer is formed for use in a multilayered ceramic device (208).

### FIELD OF THE INVENTION

The present invention relates to a multilayered ceramic device. More particularly, this invention relates to methods for manufacturing patterned green-sheets and multilayered ceramic devices.

### BACKGROUND OF THE INVENTION

Multilayered ceramic devices have a wide variety of electronic, chemical and biological applications. Generally, multilayered ceramic devices with isolated connections are used as a component in a wide variety of mechanical, electrical, biological and/or chemical devices. For example, a multilayered ceramic device with isolated connections can be used as a component in a Multilayered Microfluidic Device (MMD) that is configured to mix, react, meter, analyze and/or detect chemical and biological materials in a fluid state (i.e., gas or liquid state).

Various methods have been used to form micro features in a ceramic layer, which is commonly known as a green-sheet, that forms one of the layers of a multilayered ceramic device, such as a MMD. For example, a mechanical ceramic punch can be configured to punch out portions of a green-sheet, an embossing plate having a negative image of a pattern can be pressed against a green-sheet to imprint the pattern, or laser tooling can be used to form a pattern in the green-sheet. However, these methods have a limited ability to provide stable, compact multilayered ceramic devices with precise micro feature dimensions and/or a wide variation in micro feature aspect ratios. This is especially true when the size of the micro feature is less than about ten microns. Furthermore, mechanical punching and laser tooling do not typically provide partially recessed patterns within a green-sheet. Rather, they are generally limited to the formation of complete through-hole micro features. Hence, the depth of the micro feature is restricted to the total thickness of the green-sheet. Accordingly, it is necessary to separate an integrated thick-film function from the desired micro feature by at least one green-sheet layer. In addition, micro features having more than two sides and/or a closed micro features, such as a TESLA valve cannot be easily processed due to the lack of structural support.

Several methods are known for forming a partially recessed pattern within a green-sheet layer. For example, a green-sheet is pressed onto a mold having recessed patterns. Due to the fact that green-sheets are dense, this method may not produce satisfactory results, especially when the micro features are less than about ten microns. In order to achieve acceptable final fired density in a MMD, this method typically requires the use of high solids loading in the green-sheet, which limits deformation under a uniform and controlled condition. In addition, laser or electron beam radiation through a mask has been used to form recessed patterns on a green-sheet layer. This method is effective, but requires expensive and delicate machinery applied under carefully controlled conditions.

In view of the foregoing, it is desirable to provide simple and cost effective methods to manufacture patterned green-sheets and multilayered ceramic devices. Furthermore, additional desirable features will become apparent to one skilled in the art from the drawings, foregoing background of invention and following detailed description of preferred embodiments, and appended claims.

### BRIEF DESCRIPTION OF THE DRAWINGS

FIG. 1 is a flowchart and illustration of the cast-on-resist (COR) method of forming a casting substrate that is used to manufacture patterned green-sheets according to a preferred exemplary embodiment of the present invention;

FIG. 2 is a flowchart and illustration of the COR batch processing method used to manufacture patterned green-sheets using the casting substrates formed by the COR method according to a preferred exemplary embodiment of the present invention;

FIG. 3 is an illustration of a plastic deformation of a patterned green-sheet according to a preferred exemplary embodiment of the present invention;

FIGS. 4A and 4B are flowcharts and illustrations of the COR line casting method used to manufacture patterned green-sheets according to a preferred exemplary embodiment of the present invention;

FIG. 5 is an illustration of a green-sheet having at least one recessed pattern according to a preferred exemplary embodiment of the present invention;

FIG. 6 is an illustration of microfluidic features formed according to a preferred exemplary embodiment of the present invention;

FIG. 7 is an illustration of a Multilayered Microfluidic Device (MMD) according to a preferred exemplary embodiment of the present invention;

FIGS. 8A-8F are partial views of the MMD of FIG. 7 according to a preferred exemplary embodiment of the present invention; and

FIG. 9 is an illustration of the method for forming a MMD according to a preferred exemplary embodiment of the present invention.

### DETAILED DESCRIPTION OF THE PREFERRED EMBODIMENTS

The following detailed description of preferred embodiments is merely exemplary in nature and is not intended to limit the invention or the application and uses of the invention.

The method of forming a multilayered ceramic device with at least one and preferably multiple recessed patterns or micro features can be utilized to form any number of configurations and/or structures such as vias, channels, and cavities. As used herein, the term “via” refers to an aperture formed in a green-sheet layer. Typical vias have diameters ranging from about twenty-five to about five hundred microns. However, vias can have diameters less than about twenty-five microns to diameters approaching photolithographic limits (i.e., about one micron). Vias can also be filled in subsequent steps with other materials, such as thick-film pastes. Furthermore, as used herein, the term “channel” refers to an open region within a multilayered structure that has a length that is greater than a width. Typical channels have cross-sections ranging from about twenty-five microns to about five hundred microns. However, channels can have cross-sections less than about twenty-five microns to diameters approaching photolithographic limits (i.e., about one micron). In a MMD of the present invention, channels are typically used to transfer fluid materials. “Channels” may also be referred to as “capillaries” or “conduits.” In addition, as used herein, the term “cavity” or “well” refers to a hole, aperture or an open area. Cavities are typically used to contain, mix, react, or transfer fluid materials. Generally, cavities are connected to a channel or via to provide input or output of material and the cavity generally has dimensions greater than that of the channel or via.

Referring to FIG. 1, a cast-on-resist (COR) method 100 is illustrated for forming a casting substrate that can be used in a further manufacturing process to form a green-sheet with a recessed pattern according to a preferred exemplary embodiment of the present invention. The method 100 begins with the depositing of a layer of sensitive material on a substrate 102. The substrate can be any number of materials that can accept ceramic slurry, provide a structural support for the layer of sensitive material and/or does not strongly adhere to ceramic slurry (i.e., allows the separation of a green-sheet from the casting substrate as subsequently described in this detailed description of preferred embodiments). For example, the substrate can be MYLAR sold by DuPont Teijin Films, polyethylene sheet, polypropylene sheet, or tape-casting paper.

The layer of sensitive material, which is commonly referred to as a resist, can be any number of resists that are soluble or insoluble in a solvent after exposure to a radiation source. In this detailed description of a preferred exemplary embodiment, the layer of sensitive material is a positive resist that is soluble in a solvent after exposure to a radiation source. However, a negative resist, which is insoluble in a solvent after exposure to a radiation source, can be used in accordance with the present invention.

Once the resist is deposited on the substrate 102, a microlithography process is used to selectively expose the resist to a radiation source such that a first portion of the resist having a negative image of the recessed pattern is insoluble in a solvent and a second portion of the resist having a positive image of the recessed pattern is soluble in the solvent 104. The selective exposure of the resist can be accomplished using any number of techniques. For example, a mask with opaque and transparent regions corresponding to the first and second portions of the resist, respectively, is placed between the radiation source and the resist and the radiation source is activated to expose (e.g., radiate) the second portion below the transparent region of the mask.

The radiation source can be any number of sources that affect the solubility of the resist, such as an ultraviolet (UV) light, x-rays and/or electron beams. For example, in a photolithographic process that utilizes UV light as the radiation source, a polymer-based positive resist can be selectively exposed to UV light, which creates cross-polymerizing bonds in the resist through photo activation such that the exposed resist is soluble to an organic solvent while unexposed resist is insoluble to the organic solvent. After the resist is exposed to the radiation source 104 and any additional resist development activities are performed to develop the resist such that the first portion of the resist is insoluble and the second portion of the resist is soluble, the resist is immersed in the solvent (e.g., spraying the solvent over the surface of the resist) to remove the second portion of the resist 106.

It should be appreciated that the deposition and patterning of the resist onto the substrate previously described in this detailed description of a preferred exemplary embodiment can be accomplished with any number of techniques and variations, and two examples of these steps are provided in Appendix 1 and Appendix 2. However, it should be understood that the present invention is not limited to the methods described in Appendix 1 and Appendix 2.

While processes of the prior art would subsequently immerse the resist and substrate in a solution to remove exposed portions of the substrate (i.e., portions of the substrate that do not have a resist covering) and subsequently remove the resist with additional chemical processes, the COR method 100 of the present invention does not etch the substrate or remove the resist. Rather, the substrate and resist are configured to form a casting substrate or casting mold having the negative image of the recessed pattern provided by the first portion of the resist. It may be desirable to coat the resist with a release layer (e.g., silicone) to lower the surface energy (not shown). This will enhance the ability to separate the green-sheet from the casting substrate during a subsequent manufacturing process.

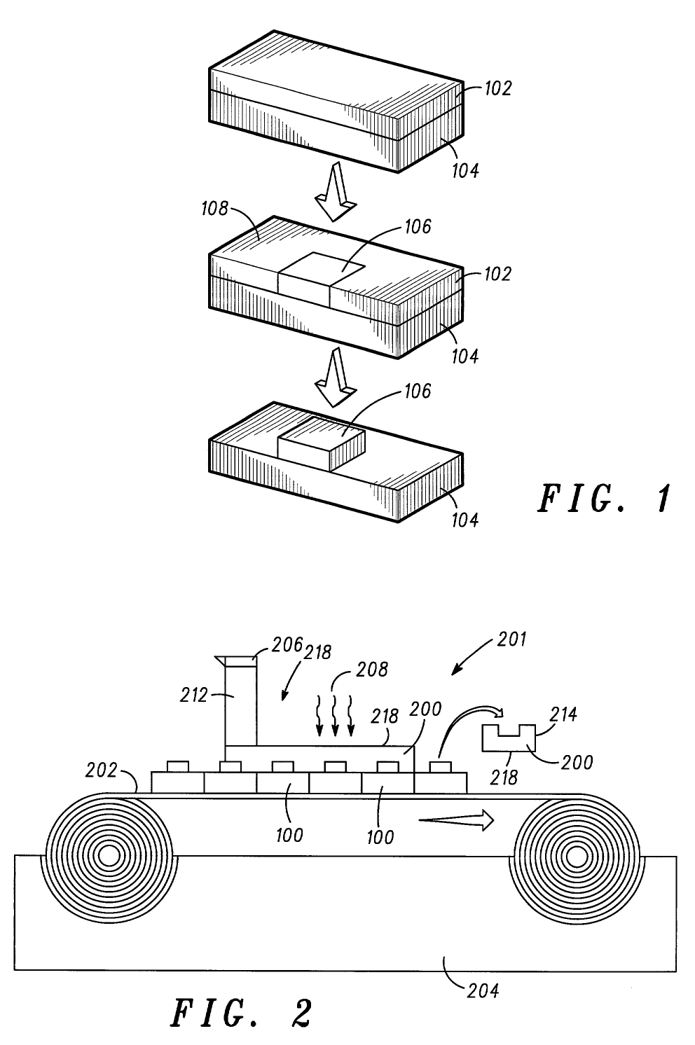

Referring to FIG. 2, a COR batch processing method 200 is illustrated for manufacturing patterned green-sheets according to a preferred exemplary embodiment of the present invention. Once multiple casting substrates having the negative image of the recessed pattern provided by the first portion of the resist are preferably formed by the COR method 100, multiple casting substrates are connected to a conveyor, a tape casting sheet placed on a tape casting system, or functionally equivalent transporting system 202. Examples of a suitable tape casting sheet include MYLAR, polyethylene sheet, polypropylene sheet, or tape-casting paper. Examples of suitable tape casting systems include Unique/Pereny Pro-Cast Series Precision Casting/Coating Machines sold by HED International and Palomar MSI Mark 155 sold by Palomar Systems and Machines, Inc.

The transporting system transports the multiple casting substrates pass through a curtain of ceramic slurry dispersed by a curtain coating machine at a controlled rate substantially over the width of a coating head of the curtain coating machine 204. By controlling the flow rate of the ceramic slurry and the velocity of the multiple casting substrates passing through the curtain of ceramic slurry, a desired thickness is obtained of the deposited ceramic slurry. An example of a suitable curtain coating machine is the Curtain Coater sold by Koating Machinery Company, Inc. Alternatively, the ceramic slurry is applied on each of the multiple casting substrates by doctor blading (not shown).

The ceramic slurry is preferably a composite material comprised of ceramic particles and inorganic particles of glass, glass-ceramic, ceramic, or mixtures thereof dispersed in a polymer binder with solvent, a polymer emulsion, or a curable binder and can also include additives such as plasticizers and dispersants. If a curable binder is used as a part of the ceramic slurry, then it is not necessary for the ceramic slurry to contain any solvent. As subsequently discussed in this detailed description of a preferred exemplary embodiment, the use of a curable binder in place of a polymer binder with solvent minimizes transfer of the recessed pattern to the top surface of green-sheet during the curing process.

The ceramic particles are typically metal oxides, such as aluminum oxide or zirconium oxide. The composition of the ceramic slurry can be custom formulated to meet particular applications. For example, applications with desired high temperature stability (i.e., temperature stability >1000° C.) can use material systems incorporating Al₂O₃ with a low glass concentration (i.e., glass of <2%). For applications preferably having an oxygen-ion conduction component, zirconia can be utilized to meet this particular application. For applications preferably having high conductivity metals, such as silver, glass-ceramics systems are used that can be co-fired with the silver metallizations at temperatures below the melting point of silver.

Components of the glass can also be tailored to provide specific properties. For example, glass that crystallizes during the sintering process can have the advantage of providing additional mechanical support or the chemistry of the glass phases and reaction with ceramic phases in the system can yield crystalline phases with desired electrical and electromagnetic performance. Some typical glass systems are lithium-aluminosilicate (Li₂O—Al₂O₃—SiO₂), magnesium-aluminosilicate (MgO—Al₂O₃—SiO₂), sodium or potassium borosilicate (Na/K SiO₂—B₂O₃). In fact, green-sheets composed of metals such as silver, palladium-silver, gold for Low Temperature Co-fired Ceramic (LTCC) or molybdenum, tungsten, and other refractory metals for High Temperature Co-fired Ceramic (HTCC) systems could be used to attain layered metal structures.

After ceramic slurry is applied on the casting substrates 204, the ceramic slurry is cured to provide a green-sheet having the recessed pattern that is formed as the ceramic slurry substantially conforms to the casting substrate that includes the remaining portion (i.e., the first portion) of the resist 206. The curing of the ceramic slurry to provide the green-sheet can be accomplished with any number techniques that are specific to the ceramic slurry. For example, the curing of the ceramic slurry can be conducted with a heating, drying, UV irradiation and/or aging process in order to remove volatile organic compounds and/or to polymerize the binding agent.

The ceramic slurry is preferably applied 204 and cured 206 to provide a green-sheet layer thickness between about fifty (50) microns to about (250) two hundred and fifty microns. However, any layer thickness can be provided in accordance with the present invention. The composition and thickness of the green-sheet can be custom formulated to meet particular applications. Techniques for casting and curing ceramic slurry into a green-sheet are described in Richard E. Mistler, “Tape Casting: The Basic Process for Meeting the Needs of the Electronics Industry,” Ceramic Bulletin, vol. 69, no.6, pp. 1022-26 (1990), and in U.S. Pat. No. 3,991,029, which are incorporated herein by reference.

After the ceramic slurry is cured on the casting substrates to provide a green-sheet having the recessed pattern that is formed as the ceramic slurry conforms or molds to the casting substrate, the green-sheet is removed from the casting substrate such that the green-sheet with the recessed pattern is separated from the casting substrate 208. However, the green-sheet having the recessed pattern can remain on the casting substrate through any number of additional processes or can be removed from the casting substrate after curing. The removal of the green-sheet with the recessed patterned is preferably accomplished so that the shapes and/or contours of the recessed pattern remain substantially intact. Often, the green-sheet is cut into six inch-by-six inch squares for processing. Although the green-sheet can be removed by peeling, the green-sheet is preferably attached to a vacuum table and secured while the casting substrate is removed, thereby preventing any potential distortion of the green-sheet.

Some of the conventional curing techniques, such as heating to remove the plasticizers can cause a transfer of the recessed pattern to the top surface of the green-sheet. Therefore, the present invention preferably minimizes transfer of the recessed pattern to the top surface of the green-sheet. The minimizing of the transfer of the recessed pattern to the top surface of the green-sheet can be accomplished according to the present invention with a curable binder system (e.g., a photopolymerizable acrylate monomer cured under UV irradiation). Exemplary curable binder systems are described in T. Chartier, C. Hinczewski, and S. Corbel, “UV Curable Systems for Tape Casting,” Journal of European Ceramic Society, 19 (1999), pp. 67-74, which is hereby incorporated by reference. The utilization of a curable binder system can reduce shrinkage of the ceramic slurry. As can be appreciated, the curable binder will undergo minimal shrinkage during curing as the solvents are not removed by drying. Rather, monomers and/or oligomers in the ceramic slurry cross link through thermal or photochemical means. Thus, pattern transfer to the top surface of the green-sheet is significantly reduced with the addition of the curable binder system.

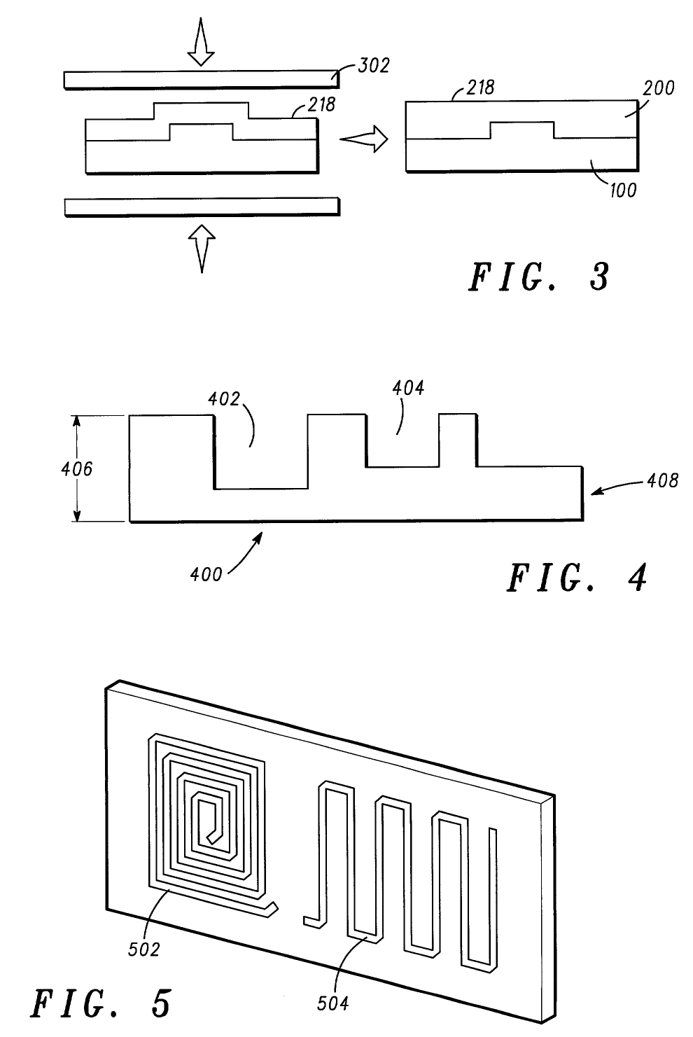

Minimizing the transfer of the recessed pattern to the top surface of the green-sheet can also be accomplished according to the present invention with plastic deformation of the green-sheet while it is still on the casting substrate. As shown in FIG. 3, a uniaxial press or calender 302 is configured to apply pressures and temperatures (e.g., temperature ranges from 50° C. to 100° C., pressure ranges from 250 psi to 1500 psi for conventional LTCC ceramic layers) to level or planarize the top surface of the green-sheet 304. This process is substantially similar to the process used for leveling a green-sheet after screen-printing features onto the surface of the green-sheet. In addition to leveling or planarizing the top surface of the green-sheet, plastic deformation can also be utilized to reduce the height of the recessed patterns or micro features contained within the green-sheet.

Referring to FIG. 4, a COR line casting method 400 is illustrated for manufacturing patterned green-sheets according to a preferred exemplary embodiment of the present invention. The method 400 utilizes the process of forming casting substrates by the COR method 100 previously described in this detailed description of preferred embodiments with reference to FIG. 1, but the method 400 is conducted on a substantially continuous line substrate (402, 404, 406). According to the method 400 of FIG. 4, the layer of sensitive material is deposited onto the continuous line substrate placed on a tape casting system 402. The continuous line substrate can be any number of materials that can accept ceramic slurry, provide a structural support for the layer of sensitive material and/or does not strongly adhere to ceramic slurry. Examples of suitable continuous line substrate include MYLAR, polyethylene sheet, polypropylene sheet, or tape-casting paper. Stainless steel can also be a suitable line substrate as long as appropriate precautions are taken to allow release of the green-sheet, such as coating the stainless steel with a release layer. The method 400 can use the same or similar tape casting system as described with reference to the method 200. The layer of sensitive material, which is commonly referred to as a resist, can be any number of resists that are soluble or insoluble in a solvent after exposure to a radiation source. In this detailed description of a preferred exemplary embodiment, the layer of sensitive material is a positive resist that is soluble in a solvent after exposure to a radiation source. However, a negative resist, which is insoluble in a solvent after exposure to a radiation source, can be used in accordance with the present invention.

Once the resist is deposited on the substrate 402, a microlithography process is used to selectively expose the resist to a radiation source such that a first portion of the resist having a negative image of the recessed pattern is insoluble in a solvent and a second portion of the resist having a positive image of the recessed pattern is soluble in the solvent 404. The selective exposure of the resist can be accomplished using any number of techniques. For example, a mask with opaque and transparent regions corresponding to the first and second portions of the resist, respectively, is placed between the radiation source and the resist and the radiation source is activated to expose (e.g., radiate) the second portion below the transparent region of the mask.

The radiation source can be any number of sources that affect the solubility of the resist, such as an ultraviolet (UV) light, x-rays and/or electron beams. For example, in a photolithographic process that utilizes UV light as the radiation source, a polymer-based positive resist can be selectively exposed to UV light, which creates cross-polymerizing bonds in the resist through photo activation such that the exposed resist is soluble to an organic solvent while unexposed resist is insoluble to the organic solvent. After the resist is exposed to the radiation source 404 and any additional resist development activities are performed to develop the resist such that the first portion of the resist is insoluble and the second portion of the resist is soluble, the resist is immersed in the solvent (e.g., spraying the solvent over the surface of the resist) to remove the second portion of the resist 406.

It should be appreciated that the deposition and patterning of the resist onto the substrate previously described in this detailed description of a preferred exemplary embodiment can be accomplished with any number of techniques and variations, and two examples of these steps are provided in Appendix 1 and Appendix 2. However, it should be understood that the present invention is not limited to the methods described in Appendix 1 and Appendix 2.

While processes of the prior art would subsequently immerse the resist and substrate in a solution to remove exposed portions of the substrate (i.e., portions of the substrate that do not have a resist covering) and subsequently remove the resist with additional chemical processes, the COR line casting method 400 of the present invention does not etch the substrate or remove the resist. Rather, the substrate and resist are configured to form a casting substrate or casting mold having the negative image of the recessed pattern provided by the first portion of the resist. It may be desirable to coat the resist with a release layer (e.g., silicone) to lower the surface energy (not shown). This will enhance the ability to separate the green-sheet from the casting substrate during subsequent manufacturing process.

Thereafter, each of the casting substrates is transported through the tape casting system during which ceramic slurry is applied by doctor blading or a curtain coating system as previously described in this detailed description of a preferred exemplary embodiment for the COR batch processing method 200 described with reference to FIG. 2 408. After ceramic slurry is applied on each of the casting substrates 408, the ceramic slurry is cured to provide a green-sheet having the recessed pattern that is formed as the ceramic slurry substantially conforms to the casting substrate that includes the remaining portion (i.e., the first portion) of the resist 410. The COR line casting method 400 can use the same or similar ceramic slurry compositions, curing processes, and methods to minimize transfer of the recessed pattern to the top surface of the green-sheet as previously described in this detailed description for preferred embodiments for the COR batch processing method 200 described with reference to FIG. 2.

After the ceramic slurry is cured on the casting substrates to provide a green-sheet having the recessed pattern that is formed as the ceramic slurry conforms or molds to the casting substrate, the green-sheet is removed from the casting substrate such that the green-sheet with the recessed pattern is separated from the casting substrate (not shown). However, the green-sheet having the recessed pattern can remain on the casting substrate through any number of additional processes (412) or can be removed from the casting substrate after curing. The removal of the green-sheet with the recessed patterned is preferably accomplished so that the shapes and/or contours of the recessed pattern remain substantially intact. Often, the green-sheet is cut into six inch-by-six inch squares for processing. Although the green-sheet can be removed by peeling, the green-sheet is preferably attached to a vacuum table and secured while the casting substrate is removed, thereby preventing any potential distortion of the green-sheet.

Upon removal from the casting substrate, a green-sheet with the recessed pattern is available for incorporation into a multilayered ceramic device. As subsequently described in greater detail, the recessed patterns or apertures in the green-sheet can be used to form micro-features such as vias, channels, and cavities. In addition, thick-film technology can be employed to incorporate conductors and dielectrics into the multilayered ceramic device.

The COR methods, which are described in preceding paragraphs of this detailed description of preferred embodiments with references to FIG. 1, FIG. 2, FIG. 3 and FIG. 4, are preferably used to form recessed patterns in green-sheets. The COR methods can provide many desirable features in the fabrication of multilayered ceramic devices. For example, vias and channels can be formed during the casting process, thereby minimizing collateral processing damage. In addition, as shown in FIG. 5, the depth of a micro feature in the green-sheet 500, such as a first channel 502 and a second channel 504, is less restricted by the thickness 506 of the green-sheet 500 as the micro feature no longer extends through the entire thickness of the green-sheet. Furthermore, an integrated thick film function can be located in relatively close proximity to the micro feature, which aids in heat transfer and temperature control. As can be appreciated by one of ordinary skill in the art, this is a desirable feature for biological applications as many biological reactions have a resolution that is about less than or equal to one degree Celsius (i.e., resolution is less than or equal to 1° C.).

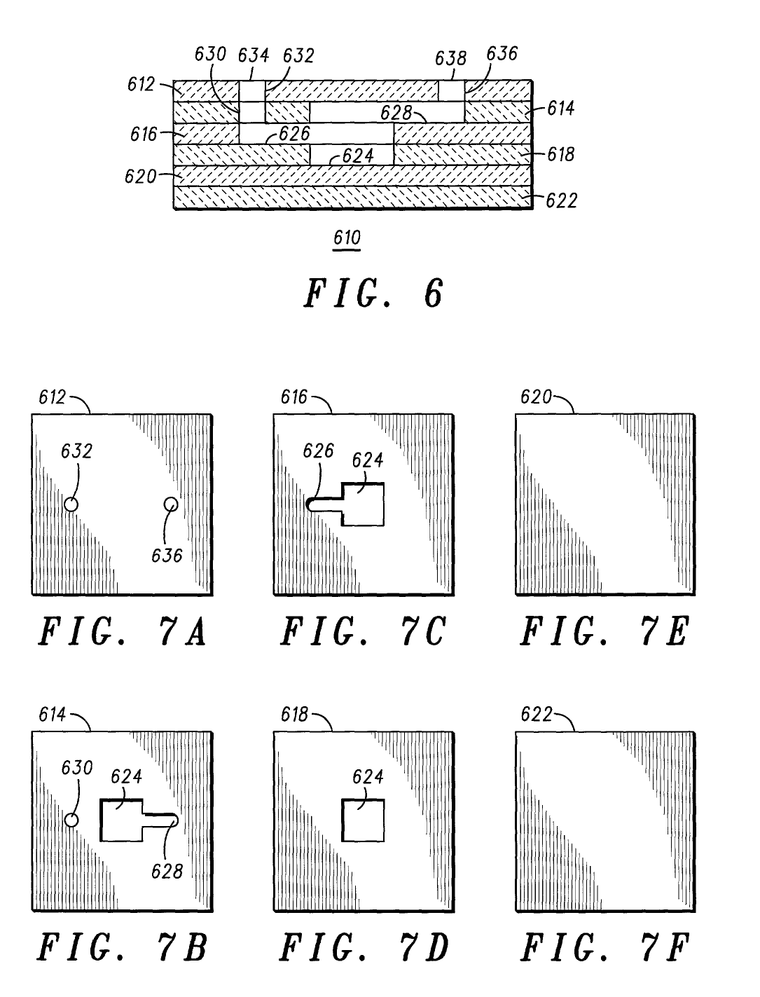

The size of the micro feature can also be controlled in about the one hundred (100) micron to about the ten (10) micron range to photolithographically defined resolution, which provides a substantially greater resolution than pattern imprinting techniques of the prior art. For example, precise definition can be achieved for micro features that are greater than about one hundred microns or less than about ten microns. Also, exposed edges of micro features and wall surfaces can be controlled as compared to the control provided with techniques of the prior art, including conventional pattern imprinting methods. Micro features with curved surfaces can be formed without stepped or jagged edges. In addition, numerous microfluidic features can be formed without the use of expensive and delicate laser or electron beam radiation machinery. For example, microfluidic features (602, 604) can be formed as shown in FIG. 6.

Once the individual green-sheets are formed with the recessed patterns according to the present invention, further processing is preferably conducted to form multilayered ceramic devices. For example, further processing is preferably conducted to form a MMD. A MMD would normally include, in addition to a fluid passageway, components that enable interaction with a fluid. Such components fall into three broad classes: (1) components that facilitate physical, chemical, or biological changes to the fluid, such as heaters, thermoelectric elements, heterogeneous catalysts, and other elements that are used for cell lysing; (2) components that allow the sensing of various characteristics of the fluid such as capacitive sensors, resistive sensors, inductive sensors, temperature sensors, pH sensors; and optical sensors; (3) components that control the motion of the fluid such as electroosmotic pumps, electrohydrodynamic pumps, and pumping using piezoelectric members or electromagnets. These component classes and a detailed description of the formation of a MMD with multiple ceramic layers are provided in International Patent Application No. PCT/US99/23324 titled “Integrated Multilayered Microfluidic Devices and Methods for Making the Same,” filed by Motorola, Inc. on Oct. 7, 1999 and published on Apr. 20, 2000, having a International Publication No. WO 00/21659, which is incorporated herein by reference; and in U.S. patent application Ser. No. 09/235081 titled “Method for Fabricating a Multilayered Structure and the Structures Formed by the Method,” filed by Motorola, Inc. on Jan. 21, 1999, which is incorporated herein by reference and hereinafter referred to as the “Integrated MMD reference”.

Referring to FIG. 7, a MMD 710 is illustrated with multiple COR patterned ceramic (green-sheet) layers (712, 714, 716, 718, 720, 722) that have been laminated and sintered together to form a substantially monolithic structure. The MMD 710 includes a cavity 724 that is connected to a first channel 726 and a second channel 728. The first channel 726 is also connected to a first via 730, which is connected to a second via 732 that defines a first fluid port 734. The second channel 728 is connected to a third via 736 that defines a second fluid port 738. In this way, the cavity 724 is in fluid communication with the first fluid port 734 and the second fluid port 738. More particularly, the first via 730, the second via 832, the first channel 726, the cavity 724, the second channel 828, and the third via 736 define a fluid passageway interconnecting the first fluid port 734 and the second fluid port 738. In this configuration, the first fluid port 734 and the second fluid port 738 can be used as fluid input or output ports to add reactants and/or remove products, with the cavity 724 providing a reaction container.

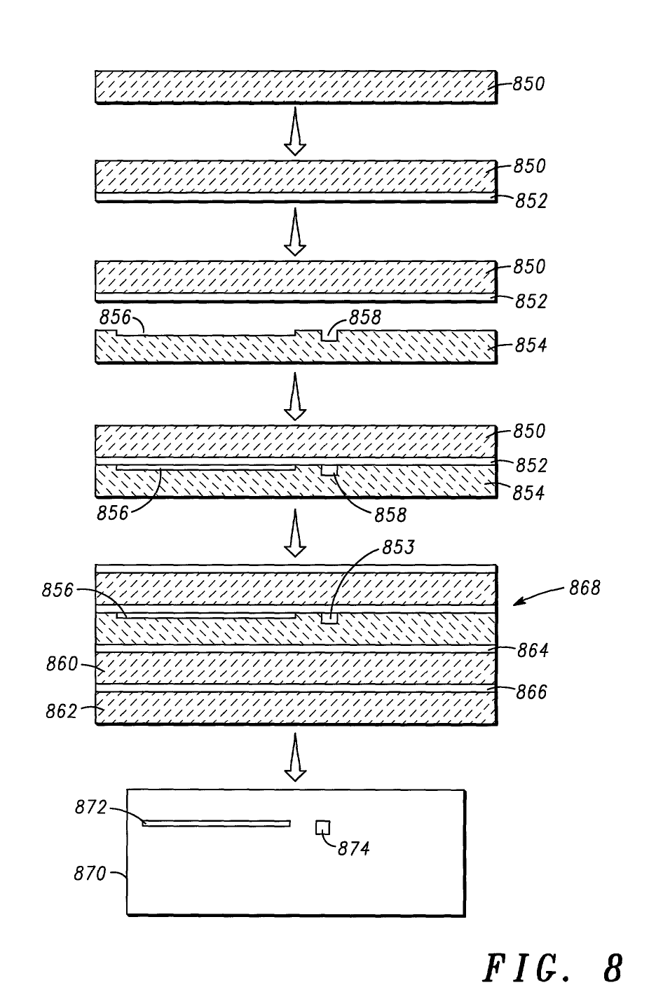

Referring to FIGS. 8A-8F, the COR patterned ceramic layers (712, 714, 716, 718, 720, 722) of FIG. 7 are shown before lamination to provide the aforementioned fluid passageway interconnecting the first fluid port 734 and the second fluid port 736. As shown in FIG. 8A, the first COR patterned ceramic layer 712 has the second via 732 and the third via 736. As shown in FIG. 8B, the second COR patterned ceramic layer 714 has the first via 730 and a portion of the cavity 724 connected to the channel 728. As shown in FIG. 8C, the third COR patterned ceramic layer 716 has a portion of the cavity 724 connected to the channel 726. As shown in FIG. 8D, the fourth COR patterned layer 818 has a portion of the cavity 824. The fifth COR patterned layer 718 and the sixth COR patterned layer 722 shown in FIGS. 8E and 8F, respectively, have no such structures.

As previously discussed in this detailed description of preferred embodiments, a multilayered ceramic device is preferably formed from the multiple COR patterned ceramic layers and further processing is conducted in order to accomplish this formation. As can be appreciated by one of ordinary skill in the art, a wide variety of materials can be applied to each of the COR patterned ceramic layers (712, 714, 716, 718, 720, 722). For example, depositing metal-containing thick-film pastes onto the COR patterned ceramic layers (712, 714, 716, 718, 720, 722) can provide electrically conductive pathways. The thick-film pastes typically include the desired material, which can be a metal and/or a dielectric that is preferably in the form of a powder dispersed in an organic vehicle, and the pastes are preferably designed to have the viscosity appropriate for the desired deposition technique, such as screen-printing. The organic vehicle can include resins, solvents, surfactants, and flow-control agents, for example. The thick-film paste can also include a small amount of a flux, such as a glass frit, to facilitate sintering. The thick-film technology and application for forming a MMD is further described in the Integrated MMD reference, J. D. Provance, “Performance Review of Thick Film Materials,” Insulation/Circuits (April, 1977), and Morton L. Topfer, Thick Film Microelectronics, Fabrication, Design, and Applications (1977), pp. 41-59, which are incorporated herein by reference.

In certain applications, the addition of glass coatings to the surfaces of the COR patterned ceramic layers is desirable. The glass coatings can provide smooth walls in the fluid passageways. Glass coatings can also serve as barriers between the fluid and the ceramic layer materials that may be reactive or otherwise incompatible with the fluid. The methods to add glass coatings to the surfaces of the ceramic layers are described in the Integrated MMD reference.

Many other materials can be added to the COR patterned ceramic layers to provide the desired functionalities previously discussed in this detailed description of preferred embodiments and the Integrated MMD reference. For example, optical materials can be added to provide optical windows. In addition, piezoelectric materials can also be added to provide piezoelectric members. Furthermore, thermoelectric materials can be added to provide thermoelectric elements and high magnetic permeability materials, such as ferrites, can be added to provide cores for strong electromagnets.

The materials of the COR patterned ceramic layers preferably have a great deal of flexibility to accommodate the addition of dissimilar materials. To ensure that the materials are reliably arranged in the multilayered ceramic device, it is preferable that the materials added to the COR patterned ceramic layers are co-firable with the ceramic layer material. More specifically, after the desired structures are formed in each of the COR patterned ceramic layers, an adhesive layer is preferably applied to either surface of each of the COR patterned ceramic layers. This technique is described in Integrated MMD reference. After the adhesive has been applied to the COR patterned ceramic layers, the COR patterned ceramic layers are stacked together to form the multilayered ceramic structure. Preferably, the COR patterned ceramic layers are stacked in an alignment die to maintain the registration between the recessed patterns of the COR patterned ceramic layers. When an alignment die is used in accordance with a preferred exemplary embodiment of the present invention, alignment holes are preferably added to the COR patterned ceramic layers to assist in the registration.

Typically, the stacking process is sufficient to bind the COR patterned ceramic layers when a room-temperature adhesive is applied to the COR patterned ceramic layers. In other words, minimal pressure is utilized to bind the COR patterned ceramic layers. However, in order to improve the binding of the COR patterned ceramic layers, lamination is conducted after the stacking process. The lamination process preferably involves the application of pressure to the stacked COR patterned ceramic layers. The lamination methods of the preferred exemplary embodiment of the present invention are described in the Integrated MMD reference.

As with semiconductor device fabrication, many devices can be present with each COR patterned ceramic layer. Accordingly, the multilayered structure may be diced after lamination using conventional ceramic layer dicing or sawing apparatus to separate the individual devices. The high levels of peel and shear resistance provided by the adhesive results in the occurrence of minimal edge delamination during the dicing process. If some layers become separated around the edges after dicing, the layers may be re-laminated with the application of pressure to the affected edges, without adversely affecting the remainder of the device.

The final processing step is firing to convert the laminated multilayered ceramic structure from its “green” state to form the finished, substantially monolithic, multilayered structure. The firing process preferably occurs in two stages. The first stage is the binder burnout stage that occurs in the temperature range of about two hundred and fifty degrees Celsius (250° C.) to about five hundred degrees Celsius (500° C.), during which the organic materials, such as the binder in the COR patterned ceramic layers and the organic components in any applied thick-film pastes, are removed from the structure.

Once the first step is complete, the second stage is initiated, which is generally referred to as the sintering stage. The sintering stage generally occurs at a higher temperature than the first state, and the inorganic particles sinter together so that the multilayered structure is densified and becomes substantially monolithic. The sintering temperature depends on the nature of the inorganic particles present in the COR patterned ceramic layers. For many types of ceramics, appropriate sintering temperatures range from about nine hundred and fifty degrees Celsius (950° C.) to about sixteen hundred degrees Celsius (1600° C.), depending on the material. For example, for a COR patterned ceramic layer containing aluminum oxide, sintering temperatures between about fourteen hundred degrees Celsius (1400°) and about sixteen hundred degrees Celsius (1600° C.) are typical. Other ceramic materials, such as silicon nitride, aluminum nitride, and silicon carbide, require higher sintering temperatures. For example, silicon nitride, aluminum nitride and silicon carbide have sintering temperatures of about seventeen hundred degrees Celsius (1700° C.) to twenty-two hundred degrees Celsius (2200° C.). For a COR patterned ceramic layer with glass-ceramic particles, a sintering temperature in the range of about seven hundred and fifty degrees Celsius (750° C.) to about nine hundred and fifty degrees Celsius (950° C.) is typical. Glass particles generally require sintering temperatures in the range of about three hundred and fifty degrees Celsius (350° C.) to about seven hundred degrees Celsius (700° C.). Finally, metal particles may require sintering temperatures from about five hundred and fifty degrees Celsius (550° C.) to about seventeen hundred degrees Celsius (1700° C.), depending on the metal.

Typically, the firing is conducted for a period of about four hours to about twelve hours or more or less, depending on the material. The firing should be of a sufficient duration so as to substantially remove the organic materials from the structure and to sinter substantially all the inorganic particles. In particular, firing should be at a sufficient temperature and duration to substantially decompose polymers and to allow for removal of the polymers from the multilayered structure.

Typically, the multilayered structure undergoes a reduction in volume during the firing process. For example, a small volume reduction of about one-half to about one and one-half percent (i.e., 0.5% to 1.5%) is normally observed during the binder burnout phase. At higher temperatures as preferably used during the sintering stage, a further volume reduction of about fourteen to about seventeen percent (i.e., 14% to 17%) is typically observed during the binder burnout phase.

As previously described in this detailed description of preferred embodiments, dissimilar materials added to the COR patterned ceramic layers are preferably co-fired with the COR patterned ceramic layers. The dissimilar materials can be added as thick-film pastes or as other COR patterned ceramic layers. The benefit of co-firing is that the added materials are sintered to the COR patterned ceramic layers and the added materials become a substantially integral component of the substantially monolithic multilayered ceramic device. However, the added materials should have sintering temperatures and volume changes due to firing that are substantially matched with those of the COR patterned ceramic layers. The sintering temperatures are largely material-dependent, so that substantially matching sintering temperatures can be accomplished with proper selection of materials. For example, although silver is a preferred metal for providing electrically conductive pathways, if the COR patterned ceramic layers contain alumina particles, which require a sintering temperature in the range of about fourteen hundred degrees Celsius (1400° C.) to about sixteen hundred degrees Celsius (1600° C.), some other metal, such as platinum, is preferably used due to the relatively low melting point of silver, which is about nine hundred and sixty one degrees Celsius (961° C.).

The volume change due to firing is preferably controlled according to a preferred exemplary embodiment of the present invention. In particular, to match volume changes in two materials, such as a COR patterned ceramic layer and a thick-film paste, the particle sizes and the percentage of organic components, such as binders, which are removed during the firing process, are preferably matched in accordance with the present invention. However, the match of the volume change does not need to be exact, but any mismatch will typically result in internal stresses in the device and the greater the mismatch, the greater the internal stress. Symmetrical processing, which involves placing a substantially identical material or structure on opposite sides of the device can compensate for shrinkage mismatched materials.

Referring to FIG. 9, an illustration of the preceding steps for forming a MMD is provided according to a preferred exemplary embodiment of the present invention. Initially, a first COR patterned ceramic layer 950 is provided with an appropriate size for further processing. A room-temperature adhesive layer 952 is applied to one surface of the first COR patterned ceramic layer 950. The first COR patterned ceramic layer 950 is then stacked with a second COR patterned ceramic layer 954 having a first internal channel 956 and a second internal cavity 988. The first COR patterned ceramic layer 950 and the second COR patterned ceramic layer 954 are stacked with a third COR patterned ceramic layer 960 and a fourth COR patterned ceramic layer 962 and a first room-temperature adhesive 964 and a second room-temperature adhesive 966 are applied to form the complete multilayered ceramic structure 968. The multilayered ceramic structure 968 is laminated as previously described in this detailed description of a preferred exemplary embodiment and fired to form the final substantially monolithic structure 970.

The use of near-zero pressures (i.e., pressures less than one hundred psi) for lamination is preferable as near-zero pressures tend to maintain the integrity of internal structures and enable the internal channel 956 and the internal cavity 958 formed in the second COR patterned ceramic layer 954 to remain as an internal channel 972 and an internal cavity 974, respectively, in the final substantially monolithic structure 970. However, other lamination processes, including conventional high-pressure lamination process, can also be used in accordance with the present invention, albeit with less control over the dimensions of internal structures. In addition, each of the COR patterned ceramic layers do not need to be laminated at near-zero pressures. More specifically, COR patterned ceramic layers that do not contain structures or materials that would be damaged or deformed by high pressures can be laminated conventionally, and this resulting structure can be laminated to other COR patterned ceramic layers using near-zero pressure lamination. An example of such a process is described in the Integrated MMD reference.

From the foregoing description, it should be appreciated that simple and cost effective methods are provided to form recessed patterns in green-sheets and multilayered ceramic devices that present benefits that have been presented in the foregoing background of invention and detailed description of preferred embodiments and also presents benefits that would be apparent to one of ordinary skilled in the art. Furthermore, while preferred exemplary embodiments have been presented in the foregoing detailed description of preferred embodiments, it should be appreciated that a vast number of variations in the embodiments exist. Lastly, it should be appreciated that these embodiments are preferred exemplary embodiments only, and are not intended to limit the scope, applicability, or configuration of the invention in any way. Rather, the foregoing detailed description provides those skilled in the art with a convenient road map for implementing a preferred exemplary embodiment of the invention. It being understood that various changes may be made in the function and arrangement of elements described in the exemplary preferred embodiment without departing from the spirit and scope of the invention as set forth in the appended claims.

### APPENDIX 1

### SU-8 Photoresist Process Description

SU-8 photoresist is available commercially from MicroChem Corp., Newton, Mass. A detailed description of the SU-8 Photoresist Processes is described in the article titled “SU-8 Automated Wafer Processing”, published by Electronic Visions, Inc. on July 26, which is hereby incorporated by reference.

SU-8 photoresist is manufactured in different standard grades. The grades are determined by the percent of solids with respect to the solvent. The resultant mixture is characterized by a viscosity, which determines the thickness versus spin speed behavior. The grade that is used in this example is SU-8 10.

### Procedure

1. Spin-coat photoresist onto substrate at 770 rpm for 30 seconds to achieve 50 micron thickness films.

2. Conduct a pre-exposure bake to remove the solvent from the resist layer after spin coating. The pre-exposure bake was performed at 70° C. for 3 minutes followed by 95° C. for 7 minutes. The substrate is cooled below the glass transition temperature (55° C.) before contacting the coated surface (i.e., exposure or cassette storage). A flat hot plate is provided in order to produce smooth and uniformly coated substrates.

3. Place mask in direct contact with the SU-8 negative photoresist and expose under a UV source. The exposure time was 250 seconds at 1.2 mW/cm².

4. The photoresist was developed in PGMEA developer (Propylene glycol methyl ether acetate).

### APPENDIX 2

### Riston Dry Film Photoresist Process Description

The materials used in this example are as follows: Riston: TM215 (1.5 mil), TM220 (2.0 mil), and CM106 (0.6 mil); a substrate of Cu foil/polyimide laminate and a developer of 1% sodium carbonate.

### Procedure

1. As Riston is typically laminated to a flexible substrate using a roll laminator to apply heat and pressure, an isostatic press was used with following lamination conditions: 10 minutes, 500-1500 psi, 70 ° C. Samples were vacuum bagged prior to insertion in the isostatic press.

2. The Mylar cover layer was removed from the Riston.

The mask was placed mask in direct contact with the

Riston and exposed under a UV source. Exposure times were 1.5-2.0 seconds at 320-360 nm at 100 mW/cm².

The resist was developed in 1% sodium carbonate solution.

1. A method of forming a ceramic layer with a pattern for use in a multilayered ceramic device, comprising:
depositing a layer of sensitive material on a substrate;
selectively exposing said layer of sensitive material to a radiation source such that a first portion of said layer of sensitive material having a positive image of the pattern is soluble in a solvent and a second portion of said layer of sensitive material having a negative image of the pattern is insoluble in said solvent;
immersing said layer of sensitive material in said solvent to remove said first portion of said layer of sensitive material to form a casting substrate having said negative image of the pattern provided by said second portion of said layer of sensitive material;
connecting said casting substrate to a transporting apparatus;
applying ceramic slurry on said casting substrate with an application apparatus as said transporting apparatus transports said casting substrate;
curing said ceramic slurry on said casting substrate with a curing apparatus as said transporting apparatus transports said casting substrate; and
separating said ceramic slurry from said casting substrate after said curing with a separation apparatus such that the ceramic layer with the pattern is formed for use in a multilayered ceramic device.

2. The method of claim 1, wherein
said transporting apparatus is comprised of a tape casting substrate connected to a tape casting apparatus that is configured to transport said tape casting substrate and said casting substrate connected to said tape casting substrate; and
said substrate and said tape casting substrate are selected from the group consisting of MYLAR≦, polyethylene, polypropylene and tape-casting paper.

3. The method of claim 1, wherein said application apparatus is a curtain coating machine.

4. The method of claim 1, wherein said application apparatus is comprised of a doctor blade.

5. The method of claim 1, wherein said selectively exposing said layer of sensitive material to a radiation source comprises:
placing a mask between said radiation source and said resist, said mask having an opaque region and a transparent region; and
activating said radiation source such that said second portion below said transparent region is exposed to said radiation source.

6. The method of claim 1, further comprising applying a release layer on at least part of said casting substrate.

7. The method of claim 1, wherein said ceramic slurry is a composite having ceramic particles and inorganic particles.

8. The method of claim 1, wherein said curing said ceramic slurry on said casting substrate includes utilization of a curable binder.

9. The method of claim 8, wherein said curable binder is an acrylate monomer.

10. The method of claim 1, wherein the separating apparatus is a vacuum table.

11. The method of claim 1, further comprising leveling the top surface of said cured ceramic slurry on said casting substrate with a plastic deformation method.

12. The method of claim 1, wherein said pattern is a partially recessed pattern.

13. The method of claim 1, wherein said pattern extends through the thickness of the ceramic layer.

14. The method of claim 1, wherein said pattern forms at least part of a micro feature selected from the group consisting of a channel, a via and a cavity.

15. A method of forming a ceramic layer with a pattern for use in a multilayered ceramic device, comprising:
connecting a line substrate to a tape casting apparatus that is configured to transport said line substrate;
depositing a layer of sensitive material on said line substrate;
selectively exposing said layer of sensitive material on said line substrate to a radiation source such that a first portion of said layer of sensitive material having a positive image of the pattern is soluble in a solvent and a second portion of said layer of sensitive material having a negative image of the pattern is insoluble in said solvent as said transporting apparatus transports said line substrate;
immersing said layer of sensitive material on said line substrate in said solvent to remove said first portion of said layer of sensitive material to form a casting substrate within said line substrate having said negative image of the pattern provided by said second portion of said layer of sensitive material as said transporting apparatus transports said line substrate;
applying ceramic slurry on said casting substrate by an application apparatus as said transporting apparatus transports said line substrate;
curing said ceramic slurry on said casting substrate with a curing apparatus as said transporting apparatus transports said line substrate; and
removing said ceramic slurry from said casting substrate after said curing such that the ceramic layer with the pattern is formed for use in a multilayered ceramic device.

16. The method of claim 15, wherein said application apparatus is a curtain coating machine.

17. The method of claim 15, wherein said application apparatus is comprised of a doctor blade.

18. The method of claim 15, wherein said line substrate is stainless steel and further comprising of applying a release layer to the stainless steel before depositing said layer of sensitive material on said line substrate.

19. The method of claim 15, further comprising applying a release layer on at least part of said casting substrate.

20. The method of claim 15, wherein said curing said ceramic slurry on said casting substrate includes utilization of a curable binder.

21. The method of claim 20, wherein said curable binder is an acrylate monomer.

22. The method of claim 15, wherein said separation apparatus is a vacuum table.

23. The method of claim 15, further comprising leveling the top surface of said cured ceramic slurry on said casting substrate with a plastic deformation method.

24. The method of claim 15, wherein said pattern is a partially recessed pattern.

25. The method of claim 15, wherein said pattern extends through the thickness of the ceramic layer.

26. The method of claim 15, wherein said pattern forms at least part of a micro feature selected from the group consisting of a channel, a via and a cavity.

27. A method for making a multilayered ceramic device, comprising:
forming a first ceramic layer;
forming a second ceramic layer having a pattern, said forming said second ceramic layer having said pattern comprising:
depositing a layer of sensitive material on a substrate;
selectively exposing said layer of sensitive material to a radiation source such that a first portion of said layer of sensitive material having a positive image of the pattern is soluble in a solvent and a second portion of said layer of sensitive material having a negative image of the pattern is insoluble in said solvent;
immersing said layer of sensitive material in said solvent to remove said first portion of said layer of sensitive material to form a casting substrate having said negative image of the pattern provided by said second portion of said layer of sensitive material;
connecting said casting substrate to a transporting apparatus;
applying ceramic slurry which is a composite having ceramic particles and inorganic particles on said casting substrate with an application apparatus as said transporting apparatus transports said casting substrate;
curing said ceramic slurry on said casting substrate with a curing apparatus as said transporting apparatus transports said casting substrate; and
separating said ceramic slurry from said casting substrate after said curing to produce said second ceramic layer;
affixing said first ceramic layer to said second ceramic layer; and
sintering said first ceramic layer and said second ceramic layer.

28. The method of claim 27, wherein
said transporting apparatus is comprised of a tape casting substrate connected to a tape casting apparatus that is configured to transport said tape casting substrate and said casting substrate connected to said tape casting substrate; and
said substrate and said tape casting substrate are selected from the group consisting of MYLAR≦, polyethylene, polypropylene and tape-casting paper.

29. The method of claim 27, wherein said application apparatus is a curtain coating machine.

30. The method of claim 27, wherein said application apparatus is comprised of a doctor blade.

31. The method of claim 27, further comprising applying a release layer on at least part of said casting substrate.

32. The method of claim 27, wherein said curing said ceramic slurry on said casting substrate includes utilization of a curable binder.

33. The method of claim 27, wherein the separating apparatus is a vacuum table.

34. The method of claim 27, further comprising leveling the top surface of said cured ceramic slurry on said casting substrate with a plastic deformation method.

35. The method of claim 27, wherein said multilayered ceramic device has at least one micro feature selected from the group consisting of a channel, a via and a cavity.

36. The method of claim 27, wherein said multilayered ceramic device has at least one component selected from the group consisting of a heater, a thermoelectric element, a heterogeneous catalyst, a capacitive sensor, a resistive sensor, an inductive sensor, a optical sensor, a temperature sensor, a pH sensor, an electroosmotic pump, an electrohydrodynamic pump, a piezoelectric member, and an electromagnet.

37. The method of claim 27, wherein said multilayered ceramic device is a multilayered microfluidic device.

38. A method for making a multilayered ceramic device, comprising:
forming a first ceramic layer;
forming a second ceramic layer having a pattern, said forming said second ceramic layer having said pattern comprising:
connecting a line substrate to a tape casting apparatus that is configured to transport said line substrate;
depositing a layer of sensitive material on said line substrate;
selectively exposing said layer of sensitive material on said line substrate to a radiation source such that a first portion of said layer of sensitive material having a positive image of the pattern is soluble in a solvent and a second portion of said layer of sensitive material having a negative image of the pattern is insoluble in said solvent as said transporting apparatus transports said line substrate;
immersing said layer of sensitive material on said line substrate in said solvent to remove said first portion of said layer of sensitive material to form a casting substrate within said line substrate having said negative image of the pattern provided by said second portion of said layer of sensitive material as said transporting apparatus transports said line substrate;
applying ceramic slurry which is a composite having ceramic particles and inorganic particles on said casting substrate by an application apparatus as said transporting apparatus transports said line substrate;
curing said ceramic slurry on said casting substrate with a curing apparatus as said transporting apparatus transports said line substrate; and
removing said ceramic slurry from said casting substrate after said curing to produce said second ceramic layer;
affixing said first ceramic layer to said second ceramic layer; and
sintering said first ceramic layer and said second ceramic layer.

39. The method of claim 38, wherein said application apparatus is a curtain coating machine.

40. The method of claim 38, further comprising applying a release layer on at least part of said casting substrate.

41. The method of claim 38, wherein said curing said ceramic slurry on said casting substrate includes utilization of a curable binder.

42. The method of claim 38, further comprising leveling the top surface of said cured ceramic slurry on said casting substrate with a plastic deformation method.

43. The method of claim 38, wherein said multilayered ceramic device has at least one micro feature selected from the group consisting of a channel, a via and a cavity.

44. The method of claim 38, wherein said multilayered ceramic device has at least one component selected from the group consisting of a heater, a thermoelectric element, a heterogeneous catalyst, a capacitive sensor, a resistive sensor, an inductive sensor, a optical sensor, a temperature sensor, a pH sensor, an electroosmotic pump, an electrohydrodynamic pump, a piezoelectric member, and an electromagnet.

45. The method of claim 38, wherein said multilayered ceramic device is a multilayered microfluidic device.
